(19) United States
(12) Patent Application Publication
(10) Pub. No.: US 2008/0196310 A1
(43) Pub. Date: Aug. 21, 2008

(54) Window shutter

(76) Inventor: Ruizhong Wang, Sunnyvale, CA (US)

Correspondence Address: RUIZHONG WANG, 459 RINCON AVE., SUNNYVALE, CA, 94086, US

(21) Appl. No.: 11/676,485

(22) Filed: Feb. 19, 2007

(51) Int. Cl. E06B 7/096

(52) U.S. Cl. 49/82.1

(57) ABSTRACT

A window shutter which can be used for interior and exterior. The window shutter has a feature that, if any side (ex., the right side to the user when he or she is facing the window) of the window needs to be blocked by some stuff, its louvers can also be adjusted from the other side of the window by the user. Two embodiments are provided to implement this feature.

### FIELD OF THE INVENTION

The present invention relates to window shutters and more particularly relates to window shutters whose louvers can be adjusted by the user.

### BACKGROUND OF THE INVENTION

Various interior and exterior window shutters are utilized both in residential and commercial business applications to control sunlight, provide privacy, and add protection from weather and architectural allure. Generally a window shutter provides 2 methods to adjust its louvers. The 1st method is to adjust the direction of the louvers, hereinafter referred to as method A. The 2nd method is to adjust the position of the louvers vertically when they are installed horizontally, or horizontally when they are installed vertically, hereinafter referred to as method B. Obviously these 2 methods have different features and can not replace each other. Conventional window shutters, while widely accepted, only allow the user to adjust the louvers by said method A on one side of window because the part for the adjustment (ex., a pole which can be twisted by the user) is located only on one side of the window after the window shutter is attached to the window opening. There is a same limitation for said method B due to the same reason. When people need to put some stuff near one side of the window for certain reason (ex., the space of the room is not big enough), it will be inconvenient for the user to adjust the louvers if the part for adjustment is blocked by the above mentioned stuff. The objective of this invention is to provide a window shutter with a feature that, if any side (ex., the right side to the user when he or she is facing the window) of the window needs to be blocked by some stuff, its louvers can also be adjusted from the other side of the window by the user.

### BRIEF SUMMARY OF THE INVENTION

Briefly, the present invention relates to a window shutter with a feature that, if any side (ex., the right side to the user when he or she is facing the window) of the window needs to be blocked by some stuff, its louvers can also be adjusted from the other side of the window by the user. Two embodiments are provided to implement this feature.

The 1st embodiment is to place the parts for adjusting the louvers by said method A and said method B on the bottom side of the top rail of the window shutter, and also place them on the same (right or left) side of the top rail of the window shutter. At the same time, the attachment of the top rail of the window shutter to the window opening is made flexible, i.e., the top rail of the window shutter can be easily detached from the window opening by the user, and then rotated together with the window shutter by 180 degrees horizontally, and then easily re-attached to the window opening by the user. After the above mentioned detach-rotate-attach action, the parts for adjusting the louvers by said method A and said method B will go to the other side of the window.

The 2nd embodiment is to provide the parts for adjusting the louvers by said method A and said method B on both right side and left side of the top rail of the window shutter.

### BRIEF DESCRIPTION OF THE DRAWINGS

The above and other objects and advantages of the present invention will be more fully understood from the following description, claims and drawings in which:

FIG. 1 is the front view of a window shutter according to the 1st embodiment of the present invention.

FIG. 2 is the front view of a window shutter according to the 2nd embodiment of the present invention.

### DETAILED DESCRIPTION OF THE DRAWINGS

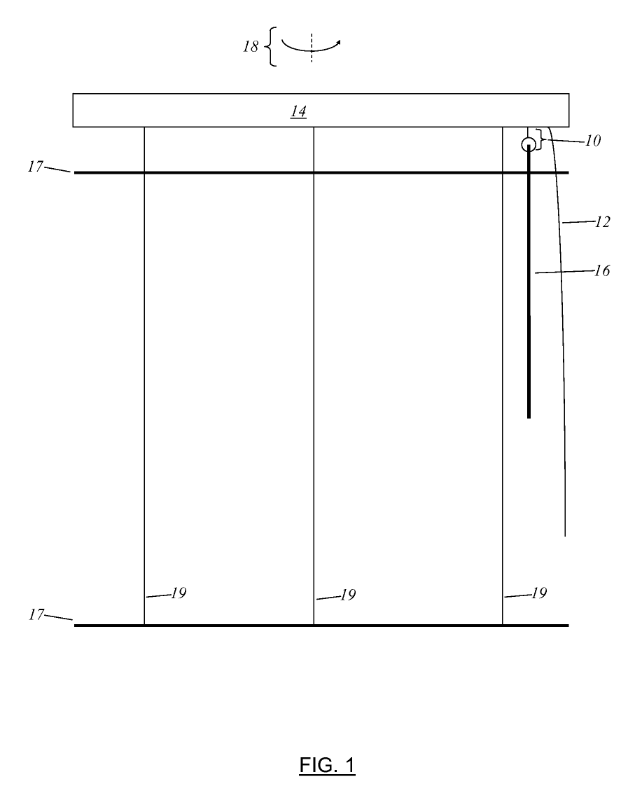

Turning now to the drawings, the front view of a window shutter according to the 1st embodiment of the present invention is shown in FIG. 1. 14 is the top rail of the window shutter. The part 10 and 16 are for adjusting the louvers by said method A. 10 is generally a part installed on 14 and 16 is generally a pole through which the user can twist 10. The part 12 is for adjusting the louvers by said method B which is generally a string. 10 and 12 are placed on the bottom side of 14, and also are placed on the same side (right side as shown in FIG. 1) of 14. At the same time, the attachment of 14 to the window opening is made flexible, i.e., 14 can be easily detached from the window opening by the user, and then rotated together with the window shutter by 180 degrees horizontally as shown by 18 in FIG. 1, and then easily re-attached to the window opening by the user. After the above mentioned detach-rotate-attach action, 10 and 12 will go to the other side of the window. Therefore, the louvers of this window shutter can be fully adjusted by the user selectively from right side or left side conveniently. Note that only two louvers 17 of the window shutter are drawn in FIG. 1 and 19 are the strings for hinging the louvers.

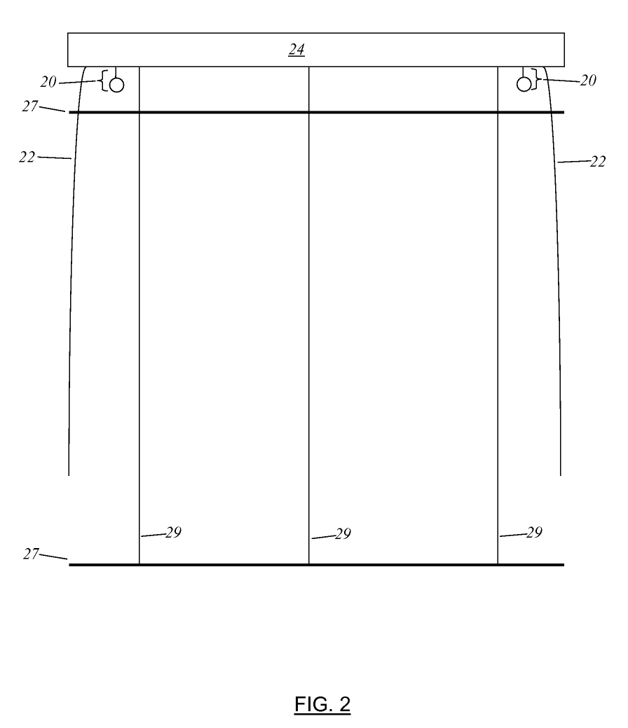

The front view of a window shutter according to the 2nd embodiment of the present invention is shown in FIG. 2., from which we can see that the parts 20 for adjusting the louvers by said method A and 22 for adjusting the louvers by said method B are provided on both right side and left side of the top rail 24 of the window shutter. Therefore, the louvers of this window shutter can be fully adjusted by the user from both right side and left side conveniently. Note that only two louvers 27 of the window shutter are drawn in FIG. 2 and 29 are the strings for hinging the louvers.

While the principles of the invention have been made clear in the illustrative embodiments set forth above, it will be obvious to those skilled in the art to make various modifications to the structure, arrangement, proportion, elements, materials and components used in the practice of the invention. To the extent that these various modifications do not depart from the spirit and scope of the appended claims, they are intended to be encompassed therein.

I claim:

1. A window shutter for interior or exterior use which has a feature that, if any side (ex., the right side to the user when he or she is facing the window) of the window needs to be blocked by some stuff, its louvers can also be adjusted from the other side of the window by the user.

2. The window shutter of claim 1 wherein the parts for adjusting the louvers are placed on the bottom side of the top rail and also are placed on the same (right or left) side of the top rail. At the same time, the attachment of the said top rail of the said window shutter to the window opening is made flexible, i.e., the said top rail of the said window shutter can be easily detached from the window opening by the user, and then rotated together with the said window shutter by 180 degrees horizontally, and then easily re-attached to the window opening by the user. After the said detach-rotate-attach action, the said parts for adjusting the louvers will go to the other side of the window.

3. The window shutter of claim 1 wherein the parts for adjusting the louvers are placed on both right side and left side of the top rail in order to allow the user to adjust the louvers from both right side and left side of the window.
